(19) United States
(12) Patent Application Publication
(10) Pub. No.: US 2026/0337059 A1
(43) Pub. Date: Oct. 29, 2026

(54) Isolating Perfluoroalkyl Substances with Recoverable Silicone Supported on Non-woven Porous Fibers

(71) Applicant: Regents of the University of Minnesota, Minneapolis, MN (US)

(72) Inventors: Joshua W. Goetze, Minneapolis, MN (US); Christopher J. Ellison, Eden Prairie, MN (US); Frank S. Bates, Saint Louis Park, MN (US)

(73) Assignee: Regents of the University of Minnesota, Minneapolis, MN (US)

(21) Appl. No.: 19/652,030

(22) Filed: Apr. 20, 2026

Related U.S. Application Data
(60) Provisional application No. 63/792,054, filed on Apr. 21, 2025.

(51) Int. Cl. C02F 1/28; B01J 20/26; B01J 20/28; B01J 20/32; C02F 101/36

(52) U.S. Cl. CPC C02F 1/288; B01J 20/264; B01J 20/28023; B01J 20/3208; B01J 20/3225; B01J 20/3276; C02F 2101/36

(57) ABSTRACT

Perfluoroalkyl substances widely contaminate fresh water sources and present a major public health concern even at trace levels. A new class of sorbent material, amine functional poly(dimethylsiloxane) exhibits an exceptionally high affinity for perfluorooctanoic acid. The amine functional siloxane was loaded into porous melt blown fibers and packed in a tubular column producing a fixed bed exhibiting a unique combination of rapid sorption kinetics and low flow resistance.

### FIELD OF THE INVENTION

Perfluoroalkyl substances (PFAS) widely contaminate fresh water sources and present a major public health concern even at trace levels. Here a new class of sorbent material is reported, amine functional poly(dimethylsiloxane) (AMS), which exhibits an exceptionally high affinity for perfluorooctanoic acid (PFOA).

### BACKGROUND OF THE INVENTION

Surfactants referred to as perfluoroalkyl substances (PFAS), while extraordinarily useful for modifying material interfaces, are linked to a plethora of adverse health effects. This has motivated setting extremely low concentration limits for drinking water, which will require the implementation of new purification infrastructure in municipal water treatment facilities. A wide variety of sorption materials have been evaluated for extracting PFAS from water, including activated carbons and ion exchange resins. Recently developed sorbents, demonstrated at a lab scale, combine high loading capacities and good selectivity by targeting the amphiphilic character of fluorinated surfactants, which contain polar and nonpolar functional groups. Commercial implementation of these new separation technologies must balance adsorption rate and capacity against practical limitations set by flow restrictions in packed columns, manufacturing costs, and disposal of contaminated products. Here an innovative and industrially relevant approach to isolating dilute amounts of the archetypical fluorinated surfactant perfluorooctanoic acid (PFOA) from fresh water is described, using melt blown porous fibers loaded with amine functionalized poly(dimethylsiloxane).

### SUMMARY OF THE INVENTION

A new class of sorbent material, amine functional poly(dimethylsiloxane) (AMS) exhibits an exceptionally high affinity for perfluorooctanoic acid (PFOA). AMS was loaded into porous melt blown poly(butylene terephthalate) fibers and packed in a tubular column producing a fixed bed exhibiting a unique combination of rapid sorption kinetics and low flow resistance.

Other methods, features, and/or advantages is, or will become, apparent upon examination of the following Figures and detailed description. It is intended that all such additional methods, features, and advantages be included within this description and be protected by the accompanying claims.

### BRIEF DESCRIPTION OF THE DRAWINGS

The novel features of the invention are set forth with particularity in the claims. A better understanding of the features and advantages of the present invention will be obtained by reference to the following detailed description that sets forth illustrative embodiments, in which the principles of the invention are used, and the accompanying drawings of which:

FIG. 1A-1B: 1A) Structures of PFOA and a short segment of amine functional polydimethylsiloxane (AMS), approximately one-tenth of the average chain length. 1B) Logarithmic reduction in PFOA concentration in 24 h batch sorption experiments. Error bars are a 95% confidence interval. Lower detection limit, LDL=1 μg/L.

FIG. 2A-2E: SEM images of a porous fiber 2A) nonwoven mat and 2B) cross section of a single fiber. 2C) Scheme for loading fibers with AMS. SEM images of AMS filled porous fiber 2D) nonwoven mat and 2E) cross section of a single fiber.

FIG. 3: Batch sorption kinetics of PFOA from DI water. Error bars represent a 95% confidence interval. Structure size ranges are ±2 standard deviations as measured by optical microscopy for GAC and AIX, and SEM for the PAC and AMS filled fibers.

FIG. 4A-4B: 4A) Pressure drop measurements for beds produced from different sorbent materials and expected flow range for fixed bed sorption operation. Dotted lines are linear fits with no intercept. 4B) Pressure drop dependance on structure size and type. Error bars on GAC and AIX pressure drop are 95% confidence intervals. Fiber bed and PAC pressure drops are single measurements. Error bars on structure size are ±2 standard deviations. *Value for PAC in 4Bb) is extrapolated using Darcy's law.

FIG. 5: Fixed bed sorption breakthrough curves for GAC, PAC, AIX, and AMS/PBT fibers with three different AMS loadings. Lines are fits to a two-parameter logistic function.

FIG. 6: ¹H NMR spectrum of AMS in deuterated chloroform.

FIG. 7A-7B: Optical microscopy images of 7A) granular activated carbon 7B) AIX beads.

FIG. 8A-8B: SEM images of 8A) Powder activated carbon 8B) AMS/PBT Fibers.

FIG. 9A-9B: 9A) Flow diagram, 9B) picture of flow system used for fixed bed sorption experiments.

FIG. 10A-10B: 10A) Flow diagram and 10B) picture of flow system used for fixed bed pressure drop experiments.

FIG. 11 Control batch sorption experiments with 20 mg/L initial PFOA concentration. Concentration was measured after 21 hours of mixing at 50 RPM on a tube rotator. “Capacity of Loading Only” calculates capacity of the AMS component excluding the fiber mass.

FIG. 12A-12B: 12A) Sorption cycling scheme for PFOA removal using AMS filled fibers. 12B) Fractional absorption and desorption of PFOA from AMS filled fibers and AMS loading stability over four sorption and regeneration cycles. Error bars are ±2 standard deviations on 3 replicates.

### DETAILED DESCRIPTION OF THE INVENTION

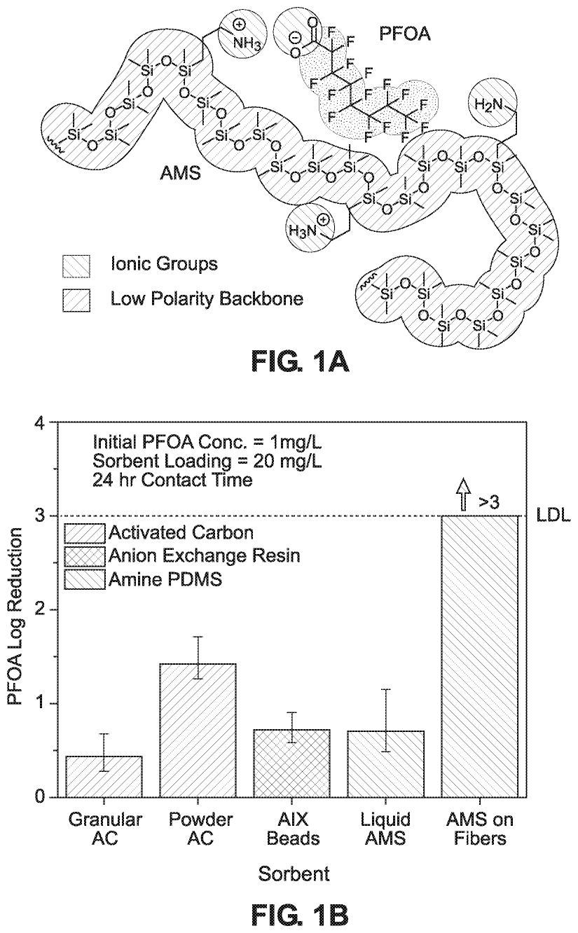

A new type of PFOA sorbent system was developed based on a copolymer of aminopropyl-methylsiloxane and dimethylsiloxane (AMS), shown in FIG. 1A. This relatively low molecular weight polymer (number average molecular weight Mₙ=20 kg/mol) contains 2.2 mmol/g polar amine functional groups appended to a highly nonpolar backbone. In low contact time experiments, AMS filled fibers extracted PFOA from 1 mg/L solutions to 1000-fold lower concentrations, reaching orders of magnitude lower levels than activated carbon and ion exchange bead resins tested under the same conditions and loading. After absorption, the PFOA was recovered using a methanol/water solution, allowing reuse of the support and sorbent over several cycles. These industrially produced amphiphilic amine-functionalized siloxanes are used in various products such as consumer fabric softeners, epoxy and urethane modifiers, and mold release agents. AMS is a viscous liquid, which precludes its direct use as a sorbent, but enables simple loading onto micron size porous fibers, which can be packed into media at volume fractions that allow facile flow of water at low pressures.

Appling these new separation technologies to industrial effluents (~1 mg/L-1 μg/L) or in environmental remediation (~1 μg/L-1 ng/L) requires balancing adsorption rate and capacity against practical limitations set by flow restrictions in packed columns, manufacturing costs, and disposal of contaminated products. For solid phase sorbents this often requires loading onto support structures or adding binders, which increases manufacturing complexity and can limit the sorption performance. Using fiber sorbents in a fixed bed system, rapid sorption kinetics can be achieved without compromising bed permeability. Here an innovative and industrially relevant approach is described for producing functionalized porous melt blown fibers and demonstrate their utility for isolating ppm levels of the archetypical fluorinated surfactant perfluorooctanoic acid (PFOA) from water.

In some aspects, a method of removing a contaminant, such as for example, a perfluoroalkyl compound contaminant from a liquid is fully described and the method including exposing a liquid that may comprise a contaminant to a sorbent, the sorbent comprising an amine functionalized siloxane, and the sorbent forming a sorbent/contaminant complex with any perfluoroalkyl compound contaminant of the liquid; followed by a step of separating the liquid from the sorbent. The sorbent absorbs the contaminant and separation of the sorbent/contaminant compound complex from the liquid removes a contaminant from the liquid.

In some aspects, a method of removing a contaminant, such as for example, a perfluoroalkyl compound contaminant from a liquid occurs by contact with the potentially contaminant containing liquid with a media comprising a sorbent formed from a copolymer of a compound comprising an amine group and a functionalized siloxane has a structure of:

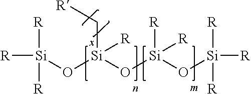

each R is independently a hydrogen, an alky or aryl group consisting of 1 to 10 carbons,
R′ is an amine or salt thereof comprising —NH2, —NHR, —NR2, —NH—(CH2)y-NH2, or —NR3+, wherein y is 1 to 12,
n is 0 to 10000,
m is 0 to 10000, and
x is 1 to 10.

In some aspects, a method of removing a contaminant, such as for example, perfluoroalkyl compound contaminant from a liquid occurs with a sorbent that is a copolymer of alkyl substituted amino group monomers and siloxane monomers. In some aspects, a method of removing a perfluoroalkyl compound contaminant from a liquid occurs with a sorbent that is formed from a copolymer of a compound comprising an amine group and a functionalized siloxane. In some aspects, the sorbent that is formed from a copolymer of a compound comprising an amine group and a functionalized siloxane and the compound comprising an amine group is an aminopropyl-siloxane, an aminoethyl-siloxane, an aminobutyl-siloxane, an aminopentyl-siloxane, an aminohexyl-siloxane, or an aminopropyl-methylsiloxane; and the functionalized siloxane is a methyl siloxane.

In some aspects, a method of removing a contaminant, such as for example, perfluoroalkyl compound contaminant from a liquid occurs with a sorbent that is a copolymer of aminopropyl-methylsiloxane and dimethylsiloxane.

In some aspects, a method of removing a contaminant, such as for example, perfluoroalkyl compound contaminant from a liquid occurs with a sorbent copolymer that comprises between 1.0 mmol/g and 50 mmol/g amine functional groups in the copolymer. In some aspects, a method of removing a contaminant, such as for example, perfluoroalkyl compound contaminant from a liquid occurs with a sorbent copolymer that comprises about 2.2 mmol/g amine functional groups in the copolymer.

In some aspects, a method of removing a contaminant, such as for example, a perfluoroalkyl compound contaminant from a liquid occurs where the sorbent is a liquid or slurry.

In some aspects, a method of removing a contaminant, such as for example, a perfluoroalkyl compound contaminant from a liquid occurs where the sorbent is a liquid or slurry and the sorbent/perfluoroalkyl compound complex is separated from the liquid by centrifugation.

In some aspects, a method of removing a contaminant, such as for example, perfluoroalkyl compound contaminant from a liquid uses a sorbent that is a liquid loaded onto a solid substrate or alternatively, the sorbent is crosslinked or is covalently linked to a solid substrate.

In some aspects, a method of removing a contaminant, such as for example, perfluoroalkyl compound contaminant from a liquid occurs where the sorbent is a liquid loaded onto a solid substrate so that separation of a perfluoroalkyl compound from the liquid occurs by flow through of the liquid through the sorbent-containing column. As liquid flows through the column, a perfluoroalkyl compound contaminant of the liquid is absorbed by the sorbent, and a sorbent/perfluoroalkyl compound complex is retained within column, thereby separating the perfluoroalkyl compound contaminant from the liquid.

In some aspects, a method of removing a contaminant, such as for example, a perfluoroalkyl compound contaminant from a liquid occurs with a solid substrate that is a nonwoven fiber. In some aspects, a method of removing a contaminant, such as for example, a perfluoroalkyl compound contaminant from a liquid occurs with a solid substrate that is a fiber or melt-blown fiber or electrospun fiber or porous fiber.

In some aspects, a method of removing a contaminant, such as for example, a perfluoroalkyl compound contaminant from a liquid occurs with a solid substrate that is a porous fiber that is formed from a polyester, a polystyrene, a polyether, polyamide, a vinyl polymer, a polyolefin. In some aspects, a method of removing a contaminant, such as for example, a perfluoroalkyl compound contaminant from a liquid occurs with a solid substrate that is a porous fiber that is formed from a polybutylene terephthalate polymer, a polyethylene polymer, a polypropylene polymer, a p-(hexaflouro-2-hydroxylisopropyl)-α-methylstyrene and styrene copolymer, a poly(4-vinylpyridine) polymer, or any combination thereof.

In some aspects, a method of removing a contaminant, such as for example, a perfluoroalkyl compound contaminant from a liquid occurs with a sorbent that includes an amine functionalized siloxane sorbent and a second sorbent that is an activated charcoal, an anion exchange resin, or a cationic exchange resin.

In some aspects, a method of removing a contaminant, such as for example, a perfluoroalkyl compound contaminant from a liquid includes an added step of collecting and processing the sorbent/perfluoroalkyl compound complex to recover the sorbent for a second use and containment of the perfluoroalkyl compound contaminant.

In some aspects, the invention includes a column for absorbing a perfluoroalkyl compound contaminant from a liquid, the column comprising an absorbent loaded onto a solid substrate or a sorbent is crosslinked or covalently linked to a solid substrate, wherein the absorbent is an amine functionalized siloxane.

In some aspects of the invention, a column includes a sorbent formed from a copolymer of a compound comprising an amine group and a functionalized siloxane, the compound comprising an amine group is, for example, an aminopropyl-siloxane, an aminoethyl-siloxane, an aminobutyl-siloxane, an aminopentyl-siloxane, an aminohexyl-siloxane, or an aminopropyl-methylsiloxane; and the functionalized siloxane is a methyl siloxane.

In some aspects of the invention, a column includes a sorbent copolymer that comprises 2.2 mmol/g amine functional groups in the copolymer.

In some aspects of the invention, a column includes a solid substrate of a porous fiber that is formed from a nylon, a polyester, a polystyrene, a polyether, polyamide, a vinyl polymer, a polyolefin. In some aspects, a method of removing a contaminant, such as for example, a perfluoroalkyl compound contaminant from a liquid occurs with a solid substrate that is a porous fiber that is formed from a polybutylene terephthalate polymer, a polyethylene polymer, a polypropylene polymer, a p-(hexaflouro-2-hydroxylisopropyl)-α-methylstyrene and styrene copolymer, a poly(4-vinylpyridine) polymer, or any combination thereof.

In some aspects, a method includes a solid substrate that is a nonwoven fiber. In some aspects of the invention, a media includes a solid substrate that is a fiber or a melt-blown fiber or electrospun fiber or porous fiber.

In some aspects of the invention, also fully described is a method of making a media for absorbing a perfluoroalkyl compound contaminant from a liquid, the method comprising: providing a blend of polymers, the blend comprising a polyester, a polystyrene, a polyether, polyamide, a vinyl polymer, a polyolefin. In some aspects, a method for making a media for a removing a contaminant, such as for example, a perfluoroalkyl compound contaminant from a liquid occurs with a solid substrate media that is a fiber or porous fiber that is formed from, a polybutylene terephthalate polymer, a polyethylene polymer, a polypropylene polymer, a p-(hexaflouro-2-hydroxylisopropyl)-α-methylstyrene and styrene copolymer, a poly(4-vinylpyridine) polymer, or any combination thereof and adding to the fiber or porous fiber with an amine functionalized siloxane.

In some aspects of the invention, also described is a method of making a media for absorbing a perfluoroalkyl compound contaminant from a liquid, the method including the use of fibers that include polystyrene polymer and a polybutylene terephthalate polymer and treatment of the fiber to form a porous fiber comprises extraction with a cyclohexane.

In some aspects of the invention, also described is a method of making a media for absorbing a perfluoroalkyl compound contaminant from a liquid, where the step of saturating the porous fiber with an amine functionalized siloxane comprises combining repeated cycles of application to the porous fiber with a solution of the amine functionalized siloxane and cyclohexane and evaporation.

### Perfluoroalkyl Substances (PFAS)

The term perfluoroalkyl substances (PFAS) generally refers to a group of substance that, while useful in numerous applications are also detrimental if found in a water supply. The term applies to large group of organofluorine chemical compounds that have multiple fluorine atoms attached to an alkyl chain. Even more broadly, any chemical with at least a perfluorinated methyl group (—CF₃) or a perfluorinated methylene group (—CF₂—) is a PFAS. An exemplary PFAS is PFOA, or perfluorooctanoic acid. Note though that the chemical structure of an amine functionalized siloxane of the present invention is generic absorbent for any organofluorine chemical compounds that have multiple fluorine atoms attached to an alkyl chain.

### PFAS Absorbent Copolymer

As described herein, the amine functionalized siloxane of the present invention is a generic absorbent for any organofluorine chemical compounds that have multiple fluorine atoms attached to an alkyl chain. Similarly, the amine functionalized siloxane is a copolymer of a functionalized siloxane and an amino-siloxane. Referring first to the functionalized siloxane, preferably the siloxane is a functionalized siloxane of the general formula:

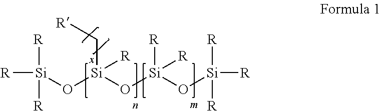

Each R is independently a hydrogen, an alky or aryl group consisting of 1 to 10 carbons,
R′ is an amine or salt thereof comprising —NH₂, —NHR, —NR₂, —NH—(CH₂)_{y}—NH₂, or —NR₃⁺, wherein y is 1 to 12,
n is 0 to 10000,
m is 0 to 10000, and
x is 1 to 10.

Of course the siloxane may be an oligosiloxane with a chain, ring, ladder, cage-like structure, or be crosslinked or branched into a larger structure.

Referring now to the second portion of the copolymer, the amino-siloxane, it is appreciated, according to FIG. 1 that the inventive compound has generally a nonpolar backbone and sufficient polar groups to interact with and absorb a PFAS molecule. Preferably those polar groups are amine groups, though other polar groups that function in a similar manner are encompassed by the present invention. Preferably the amine groups are present at a density of about 2.2 mmol/g amine functional groups in the copolymer. Though the density of amine functional groups may easily be varied depending on a specific PFAS to be targeted.

The amine group itself may be an aminopropyl-methyl siloxane.

The amine group itself may be an aminopropyl-siloxane, an aminoethyl-siloxane, an aminobutyl-siloxane, an aminopentyl-siloxane, an aminohexyl-siloxane.

The amine group itself may be an aminoethyl-methylsiloxane, an aminobutyl-methylsiloxane, an aminopentyl-methylsiloxane, an aminohexyl-methylsiloxane, aminoheptyl-methylsiloxane, aminooctyl-methylsiloxane, aminononyl-methylsiloxane, aminodecyl-methylsiloxane.

The amine group itself may be aminopropyl-ethylsiloxane, aminoethyl-ethylsiloxane, an aminobutyl-ethylsiloxane, an aminopentyl-ethylsiloxane, an aminohexyl-ethylsiloxane, aminoheptyl-ethylsiloxane, aminooctyl-ethylsiloxane, aminononyl-ethylsiloxane, aminodecyl-ethylsiloxane.

The amine group itself may be aminopropyl-akyl-substituted siloxane, an aminoethyl-akyl-substituted siloxane, an aminobutyl-akyl-substituted siloxane, an aminopentyl-akyl-substituted siloxane, an aminohexyl-akyl-substituted siloxane, aminoheptyl-akyl-substituted siloxane, aminooctyl-akyl-substituted siloxane, aminononyl-akyl-substituted siloxane, aminodecyl-akyl-substituted siloxane where the alkyl-substitute siloxane is that of formula I.

In some aspect the amine group itself may be substituted with one or more alkyl group, one or more alkene group, or one or more aromatic group.

### Fiber Formation

In some aspects a blend of the blend comprising a polystyrene, a polyester, a polyether, a polyamide, a vinyl polymer, a polyolefin, a nylon, a polybutylene terephthalate polymer, a nylon, or any combination thereof. In some aspects, the blend comprises a polyether, a polyamide, a vinyl polymer, a polyolefin, a cellulose, a polysiloxane, or any combination or blend of two or more of these polymers.

In some aspects the fiber formation may rely upon use of a polybutylene terephthalate polymer, a polyethylene, a vinal acetate, an isoprene, a poly acrylamide, a poly acetonitrile, a poly tetrafluoroethylene, a LDPE poly ethylene, a HDPE polyethylene, a poly propylene, polyvinyl alcohol, a p-(hexaflouro-2-hydroxylisopropyl)-α-methylstyrene polymer, a poly(4-vinylpyridine) polymer, or any combination or blend of these polymers forms the basis for preparation of a fiber according to the invention. In some aspects a melt-blowing method of fiber formation is used. It is appreciated however that method of fiber formation is encompassed by the invention including wet cool gel spinning, thermoplastic fiber spinning, melt blowing, spun bonding, electrospinning, rotary spinning, continuous filament producing operations, tow fiber producing operations, and combinations thereof. In some aspects, fiber creation employ a melt whose composition forms a co-continuous immiscible blend as a feedstock for melt blowing.

### Porosity of Fibers

The porosity of fibers is determined by numerous experimental parameters. The co-continuity of fiber formation enables removal of a majority of a dissolvable component so that an insoluble component forms the walls of the pores that are robust in this application. In some embodiments, the porosity is affected by treatment of a fiber blend with cyclohexane, though the system of fine-tuning porosity of the fiber is usable with other solvents/dissolvable fiber component that are known in the art. The purpose of the porosity is to provide significant surface area to allow fast PFAS absorption kinetics using the absorbent described herein. Fine-tuning of pore size and fiber diameter will fine tune the methods allowing for maximal PFAS absorption while managing pressure drop when the fiber when used in a column format. In some aspects the pore volume is just as important as surface area since the pore volume may act to retain the loaded absorbent. The ideal fast absorption kinetics between an absorbent and contaminant are derived form a combination of fiber diameter, surface area, fiber pore volume, fiber pore size, and the connectivity of the pore structure of the fiber.

### Loading Amine Functionalized Siloxane

In general, the fiber is loaded with an amine functionalized siloxane as a PFAS absorber.

The amine functionalized siloxane may be in the form of a liquid, or viscous liquid, or slurry that is applied to the fiber. The amine functionalized siloxane may be adhered to the fiber via a covalent linkage between the siloxane backbone and the fiber or crosslinked. In some aspects the amine functionalized siloxane is added to the fiber in a mixture with an evaporable solvent.

### Columns and Media

In some aspects the fibers, loaded with amine functionalized siloxane are used in a column format. In some aspects, the sorbent is loaded on a media, a porous media, a fiber, a porous fiber. The media may be considered a support for the sorbent. In some aspect a porous media may help with retention of the absorbent, though it is not required for the media to be porous to practice the invention. In some aspects, the porosity of the media or fiber may increase the surface area available for the sorbent. In some aspects the media is fibrous, a film, granular or a particulate.

The sorbent is loaded onto a media. In some aspects the media is saturated with the sorbent. In some aspects the media is sub-saturated with the sorbent and will yet provide ample sorbent for the intended purpose of forming and retaining a sorbent/contaminant complex. In some aspects a covalent bond between the sorbent and the media is formed. In some aspects, the sorbent is applied to the media in multiple applications with drying time in between applications. The number of applications is not particularly limited. Again, the purpose of applying the sorbent to the media is to form a product with sufficient capacity to provide fast reaction kinetics of the sorbent and contaminant interaction while also retaining the sorbent/contaminant complex within or on the media.

### Recovery of PFAS and Resuse of AMS Copolymer

In some aspects, once an amine functionalized siloxane absorbent has absorbed a PFAS, for example, after a liquid containing a PFAS contaminant has passed through a column containing a fiber loaded with an amine functionalized siloxane absorbent, the contents of the column itself may be used to collect for proper disposal of the PFAS contaminant and collection of the amine functionalized siloxane for reuse. In some instances, such as if the amine functionalized siloxane is crosslinked or is covalently linked to the fiber, removal of the PFAS contaminant will result in a refreshed fiber ready for further PFAS removal.

### DEFINITIONS

As used in the specification and the claims, the singular forms “a,” “an,” and “the” include plural referents unless the context clearly dictates otherwise. About” is used to provide flexibility to a numerical range endpoint by providing that a given value may be “slightly above” or “slightly below” the endpoint without affecting the desired result. The use herein of the terms “including,” “comprising,” or “having,” and variations thereof, is meant to encompass the elements listed thereafter and equivalents thereof as well as additional elements. As used herein, “and/or” refers to and encompasses any and all possible combinations of one or more of the associated listed items, as well as the lack of combinations where interpreted in the alternative (“or”). As used herein, the transitional phrase “consisting essentially of’ (and grammatical variants) is to be interpreted as encompassing the recited materials or steps “and those that do not materially affect the basic and novel characteristic(s)” of the claimed invention. Thus, the term “consisting essentially of’ as used herein should not be interpreted as equivalent to “comprising.”

Moreover, the present disclosure also contemplates that in some aspects, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered expressly stated in this disclosure. Unless otherwise defined, all technical terms used herein have the same meaning as commonly understood by one of ordinary skill in the art to which this disclosure belongs.

The term sorbent is defined as a material that sorbs or enables sorption of another substance. That is a sorbent has the capacity or tendency to take it up by either absorption or adsorption. As such the terms sorbent, adsorbent, absorbent all interchangeably describe the interaction between a perfluoroalkyl compound contaminant and the amine functionalized siloxane as described herein.

Where methods and steps described herein indicate certain events occurring in certain order, those of ordinary skill in the art will recognize that the ordering of certain steps may be modified and that such modifications are in accordance with the variations of the invention.

Additionally, certain steps may be performed concurrently in a parallel process, when possible, as well as performed sequentially.

The meaning of abbreviations is as follows: “°C” means Celsius or degrees Celsius, as is clear from its usage, “s” means second(s), “min” means minute(s), “h,” “hr,” or “hrs” means hour(s), “psi” means pounds per square inch, “nm” means nanometers, “d” means day(s), “μL” or “uL” or “ul” means microliter(s), “mL” means milliliter(s), “L” means liter(s), “mm” means millimeter(s), “nm” means nanometers, “mM” means millimolar, “μM” or “uM” means micromolar, “M” means molar, “mmol” means millimole(s), “μmol” or “uMol” means micromole(s)”, “g” means gram(s), “μg” or “ug” means microgram(s) and “ng” means nanogram(s), “% w/v” means weight/volume percent, “% v/v” means volume/volume percent, “rpm” means revolutions per minute, “HPLC” means high performance liquid chromatography, and “GC” means gas chromatography.

While various embodiments of the present invention have been shown and described herein, it is emphasized that such embodiments are provided by way of example only.

Numerous variations, changes, and substitutions may be made without departing from the invention herein in its various embodiments.

### EXAMPLES

The examples herein provide some examples, not meant to be limiting. All reagents, unless otherwise indicated, are obtained commercially.

The following MATERIALS and METHODS are common to the Examples

The aminopropyl-methylsiloxane-co-dimethylsiloxane (AMS-1203) was obtained from Gelest Inc. Polybutylene terephthalate (Celanex 2008) was supplied by Atmus filtration. The unfunctionalized polystyrene (43011-0) was purchased from Sigma Aldrich. The monohydroxy-terminated polystyrene was obtained from Scientific Polymer Products (part number 297). Cyclohexane (CHX) was purchased from Fisher (ACS Grade, C556-4). Perfluorooctanoic acid (17146-8), Ammonium Acetate (73594-25G), Biotin B7 (B4639-500MG) and LCMS Grade Methanol (MX0486-1) were obtained from Sigma Aldrich. Hexafluoroisopropanol (HFIP, product no. 147541000) was purchased from Acros. DARCO granular (GAC, product no. 242268) and powder (PAC, product no. 242276) activated carbons and Amberlite IRA-190 (product no. 06457) were purchased from Sigma Aldrich as benchmark sorbents.

### Characterization Methods

Nuclear Magnetic Resonance Spectroscopy (NMR). All NMR spectroscopy was conducted using a Bruker Avance III HD 500 MHz. ¹H NMR spectrums of AMS-1203 were collected in deuterated chloroform (20 mg/mL) and used to determine the amine content of the AMS-1203 by comparing the integration of the dimethyl siloxane protons to the protons on the aminopropyl groups (FIG. 6).

¹⁹F NMR was used to determine the PFOA concentration in the samples from the fixed bed sorption experiments. Eluted water samples were dosed with 10% by mass of 1 mg/L HFIP internal reference stock solution. PFOA concentration was calculated from the relative integrations between the —CF₃ signals of the HFIP and PFOA.

Liquid Chromatography-Mass Spectrometry (LC-MS). Water samples were mixed with 2% by volume of a Biotin stock solution (25 μM) before analysis to verify injection quality. PFOA standards with the same concentration of Biotin were prepared at concentrations of 10, 32, 100, 316, 1000, and 3162 nM and were run before and after each batch of samples.

LC-MS measurements were conducted on a Thermo Scientific UltiMate 3000 liquid chromatography system with a Kinetex C18 column (Phenomenex, 50×2.1 mm, 2.6 μm resin) and a Thermo Scientific TSQ Endura triple-quadrupole mass spectrometer in negative ion mode. For LC, buffer solutions of 20 mM Ammonium Acetate (A) and Methanol (B) were used. 20 μL of sample was injected at 5% B. The composition was held for 1 minute before increasing linearly to 90% B over 9 min. The composition was held for 2.5 minutes before decreasing back to 5% B over 1 min and stabilizing for 4.5 min prior to the next injection. The mass spectrometer parameters are summarized in Table 1 below:

| Parameter | Value | |
|---|---|---|
| Source Voltage | 3000 | V |
| Ion Transfer Tube | 333 | °C |
| Temperature | | |
| Vaporizer Temperature | 350 | °C |
| Precursor Ion (Q1) | 413 | m/z |
| Product Ion (Q3) | 369 | m/z |
| Collison Energy | 10 | V |
| Collison Gas Pressure | 1.5 | mTorr |

Optical Microscopy (OM). Images of the GAC and AIX sorbents were collected for structure size characterization using an Olympus BX53 optical microscope. AIX were imaged after soaking in water overnight to ensure the beads were fully swollen.

Scanning Electron Microscopy (SEM). SEM was conducted using a FEI Helios NanoLab G4 Scanning Electron Microscope. All samples were affixed to SEM stubs using carbon tape and coated with 3 nm of Pt using a Leica ACE600 sputter coater. Powder activated carbon and melt blown fiber mat samples were imaged on flat SEM stubs. Cross sections were obtained by embedding fiber mats in quickset epoxy (Loctite® Epoxy General Purpose 5 Minute), curing overnight at 50 °C, and fracturing under liquid nitrogen.

Average Particle and Fiber Diameters. Average particle and fiber diameters were measured across 7-10 optical microscopy (GAC and AIX) or SEM (for PAC and AMS Fibers) images using the ImageJ image analysis software. Error bars on structure size (and

$$1 / {d}_{av}^{2} )$$

are reported to +2 standard deviations to provide the range of structure sizes present in each sorbent type.

### Sample Preparation and Experiment Details

Porous Fiber Preparation. Porous PBT fibers were prepared as described previously (Goetze ACS Marco. Lett. 2024). Summarized, cocontinuous PBT/PS/PSOH blends (35:60:5 by weight) were produced in a recirculating twin screw extruder (Xplore 15 cc Microcompounder) and melt blown using a lab scale system, conducted at 265 °C with an air flux and polymer flowrate of 17 g/min/mm² and 0.34 cm³/min/hole, respectively, using a single 0.25 mm diameter orifice. Fibers were collected on a rotating drum at a 20 cm die-to-collector distance. The templating PS phase was extracted by soaking strips of the fiber mats in 40 °C CHX overnight.

Blend Preparation. PBT/PS/PSOH blends were prepared in a 15 cc Xplore Microcompounder. Before blending, PBT and PS pellets were dried in a vacuum oven at 80 °C for at least 15 h. PBT pellets (4.82 g) were dry mixed with PSOH powder (0.60 g) before adding to the microcompounder and blending at 265 °C and 100 RPM for 5 min. The PS pellets (6.58 g) were added before increasing to 200 RPM and blending for another 6 min. The blends were quenched in cool tap water.

Melt Blowing. Blends were cut into pellets (~3 mm diameter) and dried at 80 °C for at least 15 h and melt blown using a custom built lab-scale system, that has been described elsewhere. Polymer was packed into a heated chamber at 230 °C before heating to 265 °C for melt blowing. Fibers were produced using a single 0.25 mm orifice die with a sharp tip (tip edge radius<orifice radius). Rectangular cross section air slots (10×1.1 mm) converged at an angle of 56°. The die setback distance was 1.65 mm. Polymer and air flow rates were 0.34 cm³/min/hole and 5.5 SCFM, respectively. Fibers were collected on a rotating drum collector at a die-to-collector distance of 20 cm.

Extraction of Polystyrene to Produce Porous Fibers. Strips of the PS/PBT blend fiber mats were cut into 5×2 cm rectangles, fixed between a wire mesh and a reinforced Teflon sheet, and placed at the bottom of a crystallization dish filled with cyclohexane. The bath was covered, stirred, and heated on a hotplate at 40 °C for at least 15 h. The fiber strips were removed and dried in a vacuum oven at 50 °C for 4 h to remove cyclohexane.

Fiber Loading with Amine Functional Polydimethylsiloxane.

For batch sorption testing, porous fiber mats were cut into 10 mm diameter discs using a punch and weighed. The fiber discs were repeatedly wetted with 200 μL of a 50 mg/mL solution of AMS in cyclohexane on a vacuum funnel setup. A 6 cm diameter fine glass frit funnel over a vacuum Erlenmeyer flask is used. The frit was covered with a foil disc cut to the funnel diameter with a 10 mm hole in the center to place the fiber samples during dosing. With the Erlenmeyer flask under active vacuum, this configuration quickly removes excess AMS solution and provides a low air flow through the mat to accelerate evaporation of the cyclohexane prior to the next dose. Samples were dosed 8 (±1) times to target a 1 (+0.1) mg loading on the fiber discs. Samples were dried on the vacuum filter for 1 minute between doses. Discs were then dried in a vacuum oven at 50 °C for 15 h to remove residual solvent.

For pressure drop measurements and fixed bed sorption measurements, due to the larger volume of material necessary, strips of porous fibers were coated directly. Strips were dipped in a 100 mg/mL AMS solution in CHX and hung to dry in a fume hood before dipping and drying again. Samples were then dried in a 50 °C vacuum oven to remove residual solvent. This method of dosing provided similar average loadings (~50% mass) and pore filling as the vacuum filter method. The vacuum filter method was used for the batch sorption experiments purely because it allows greater control of the AMS loading and direct loading measurement.

For additional fixed bed sorption experiments, porous fibers were packed into a glass tube with an inner diameter of 9.3 mm to produce a 5 mm long bed using glass rods. The bed was slid to one end of the tube and trimmed with a razor blade to produce a flat surface before sliding to the opposite side and trimming the other side. AMS was loaded onto the bed, by fully wetting the bed with a 150 mg/mL solution of AMS and slowly bubbling nitrogen through the bed to evaporate the cyclohexane. The bed and tube were dried in a vacuum oven at ambient temperature for 3 h to remove residual solvent. This method provided a lower AMS loading of 38% mass.

### Batch and Fixed Bed PFOA Sorption Experiments

Batch sorption experiments were conducted in polypropylene conical tubes filled with 50 mL of 1 mg/L PFOA solution. PAC, GAC, AIX, and AMS (on PBT fibers) were added to the tubes at a sorbent loading of 20 mg/L. The solutions were mixed on a tube rotator (Fisher Scientific, product no. 88-861-049) at 50 RPM. Samples from the supernatant (0.5 mL) were taken at various time points to measure the removal of PFOA and measured using liquid chromatography mass spectrometry (LCMS).

Continuous sorption experiments were conducted by pumping 20 mg/L PFOA solution at 2 mL/min through a 9.3 mm inner diameter glass column packed with the various sorbents. Quartz chips were packed before and after the sorbents to provide uniform flow across the beds. Samples were taken at the outlet, dosed with a 1 mg/L HFIP stock solution, and measured using ¹⁹F nuclear magnetic resonance spectrometry.

Batch Sorption Experiments. Additional batch kinetics experiments were conducted in 50 mL polypropylene conical tubes. PAC, GAC, AIX, and AMS (on PBT fibers) were added into the tubes at a sorbent loading of 20 mg/L. The AIX was measured to contain 58% water by mass as shipped from the manufacturer, so 2.4 mg of water laden resin was used in each tube. The mass of the fiber support was neglected in the loading, as the support is viewed as similar to the stagnant water filled pore space in the activated carbons and the ion exchange resin. PAC, GAC, and AIX were soaked in 0.5 mL of deionized water in the conical tubes for 15 h before conducting the sorption experiments to allow the pore space to fill with water. AMS/PBT fibers were flushed with 1 L of deionized water at 50 mL/min using the flow system (described below) prior to adding to the conical tubes. The conical tubes were filled with 50 mL of 1 mg/L PFOA stock and placed on a tube rotator (Fisher Scientific, 88-861-049) at 50 RPM to mix. At each time point, 500 μL of supernatant was sampled for LCMS measurement. The PAC and GAC tubes were centrifuged at 2500 RPM for 3 min in a benchtop centrifuge (Thermo Scientific CL2) to pellet any generated fines before sampling. Three separate tubes were prepared as replicates for each sorbent type. Control samples with no sorbent, using the same procedure, showed no measurable sorption of PFOA. Similarly, the porous PBT fibers without AMS showed no significant PFOA sorption. Error bars on the measurements are a 95% confidence interval.

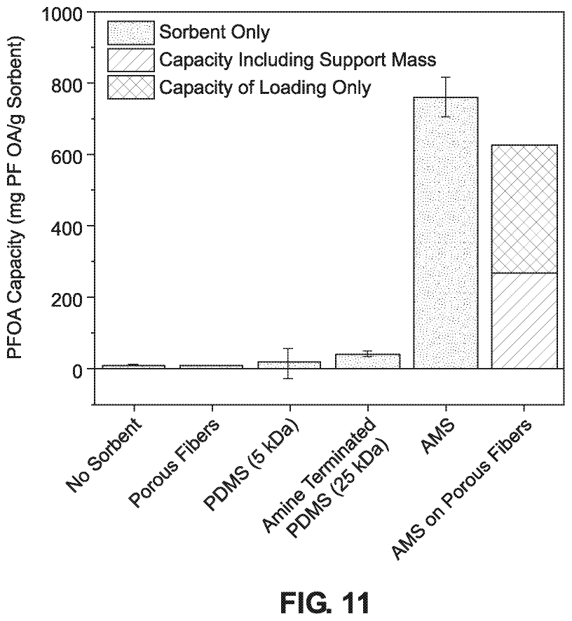

FIG. 11 shows the average specific sorption capacity of the porous fibers, three different grades of liquid PDMS, and AMS loaded onto the porous fibers. All samples contained 50 mL of 20 mg/L PFOA initially, were mixed on a tube rotator at 50 RPM and the supernatant was sampled for PFOA removal after 21 hours. The remaining concentration of PFOA was measured using NMR as described above. A 2 mg sample of the neat (i.e., no AMS loaded) porous fibers was tested. Liquid absorbent samples were wetted to the side of the sample tubes. Sample vials were prepared and tested at three different loadings of DMS-A31 (α,ω-Amine Terminated 25 kDa PDMS) between 3 and 7.5 mg. Similarly, for DMS-S21 (5 kDa PDMS), between 1.5 and 3.5 mg, and AMS-1203 (aminopropyl-methylsiloxane-co-dimethylsiloxane, AMS) between 0.8 and 1.3 mg. Higher loadings of AMS-1203 were also tested, but reduced the PFOA concentration to below the detection limit of the NMR method. The AMS loaded fibers tested contained 0.79 mg of porous fibers and 0.58 mg of AMS-1203. Minimal spreading of the DMS-A31 and AMS-1203 was observed during the sorption test. The DMS-S21 spread to coat the inside of the sample tube.

The specific capacity of each sorbent was calculated by dividing the mass of PFOA removed by the mass of sorbent used. For the AMS loaded fibers, specific capacity including the mass of the porous fibers (“Capacity Including Support Mass”) and only including the mass of AMS (“Capacity of Loading Only”) are shown. The former gives the specific capacity of the fiber-supported absorbent system. The latter demonstrates that when loaded onto the porous fibers, the AMS retains more than 80% of the capacity of the unsupported, neat AMS.

Pressure Drop Measurements. Pressure drop measurements were conducted on a recirculating flow system with the same glass column as the fixed bed sorption experiments. Beds of three different lengths were packed with the AIX and GAC sorbents (40-60 cm). For the fiber beds, AMS filled mats were either trimmed to 8 mm long strips and rolled together to form a cylindrical bed or cut into 10 mm diameter discs which were individually pressed into the column. Pressures were measured at flowrates ranging from 2 to 50 mL/min. The flow resistance of the empty bed was subtracted from all measurements.

For additional flow resistance measurements, the flow system was reconfigured into a recirculation mode, as shown in FIG. 10. Three different length beds (40-60 cm) were packed for both the AIX and GAC measurements. For the AMS/PBT fiber beds, two packing methods were used. The first used 4-5 cm long, 8 mm wide strips of the AMS filled fibers, rolled together to produce a cylinder with a 9.5 mm diameter and 8 mm length, which was then fit into the glass tube. The second used 26, 10 mm diameter AMS/PBT fiber discs, cut with a punch, which were individually inserted into the glass tube and tamped using a flat tip glass rod to produce a 3 mm long bed. For measurements on the AIX, GAC, and the layered fiber disc beds, a vertical tube, acting as a manometer was used, providing far greater repeatability and resolution at the low pressures than a dial gauge. The pressure drop of the empty column was subtracted from all measurements.

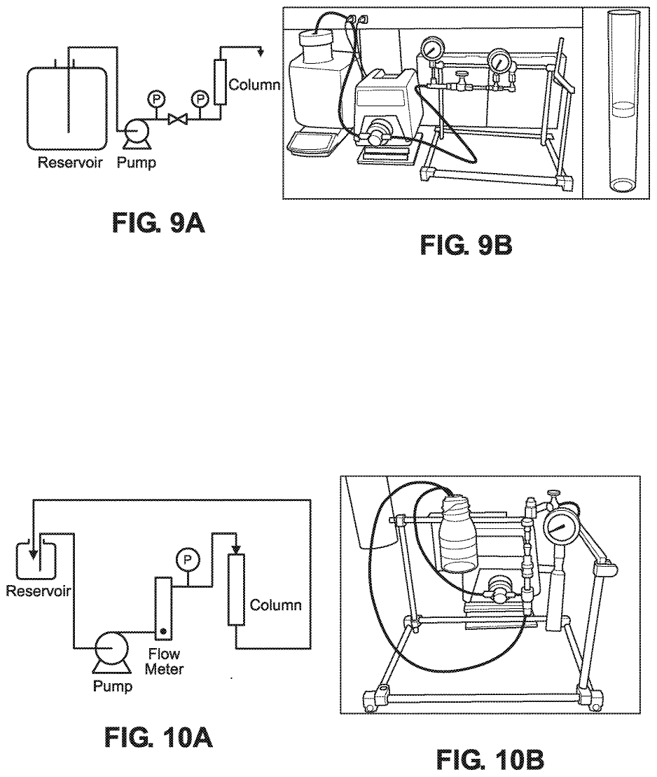

Fixed Bed Sorption Experiments. The fixed bed sorption experiments were conducted using a 10 L feed carboy, gear pump (Cole Parmer, 75211-70 with a P35 pump head), and a glass tube with a ⅜ in. outer diameter and 9.3 mm inner diameter, as shown below in FIG. 9A-9B.

The PAC and GAC beds were 5 mm long and the AIX bed was 6 mm long. The PAC column was prepared by lightly packing PAC between two thin layers of glass wool, filling the reminder of the glass tube with 4-20 mesh quartz chips (Sigma Aldrich 342831-100G). The PAC column was tested in an up-flow configuration.

The GAC and AIX beds were prepared by removing the upstream fittings on the glass tube and backfilling with water. Quartz chips were added to fill ~⅓ of the column and leveled with a flat tip 9 mm diameter glass rod, before pressing in a 100 mesh wire disc, trimmed to fit tightly in the column. GAC and AIX soaking in water were then added with a transfer pipette, keeping the water level above the packing to avoid trapping air bubbles in the bed. Once leveled, another wire mesh disc was inserted before filling the remainder of the column with glass beads and reattaching the top fittings. The GAC and AIX beds were tested in down-flow.

The AMS beds were prepared between beds of quartz chips similar to the GAC and AIX beds described above and by using the disc stacking method described above in the pressure drop measurement section. Fiber discs with varying loadings of AMS were used to achieve the different AMS bed concentrations. The 90, 140, and 180 mg AMS/mL beds had bed lengths of 5, 5, and 3.5 mm, respectively. All the AMS bed were measured in down-flow. The 20 mg/L PFOA feed solution was pumped through the test column at 2 mL/min. The pressure drop of the quartz chip bed was subtracted from the stable pressure drops measured during the PAC and AMS/PBT fiber experiments to determine the bed pressure drops.

Outlet samples were collected and measured using the ¹⁹F NMR method described above.

Fitting Breakthrough Curves. Breakthrough curves were fitted to a two-parameter logistic equation shown in Equation Si below, where C/C₀ is the outlet concentration normalized by the inlet concentration, BV is the number of empty bed volumes which have eluted through the system since the start of the experiment, BV_{0.5} is a fit parameter denoting the number of bed volumes where C/C₀=0.5, and n defines the sharpness of the breakthrough profile. A higher n corresponds to a sharper breakthrough.

$$\frac{C}{{C}_{0}} = \frac{{e}^{n ( BV - {BV}_{0.5} )}}{1 + {e}^{n ( BV - {BV}_{0.5} )}} \qquad ( 1 )$$

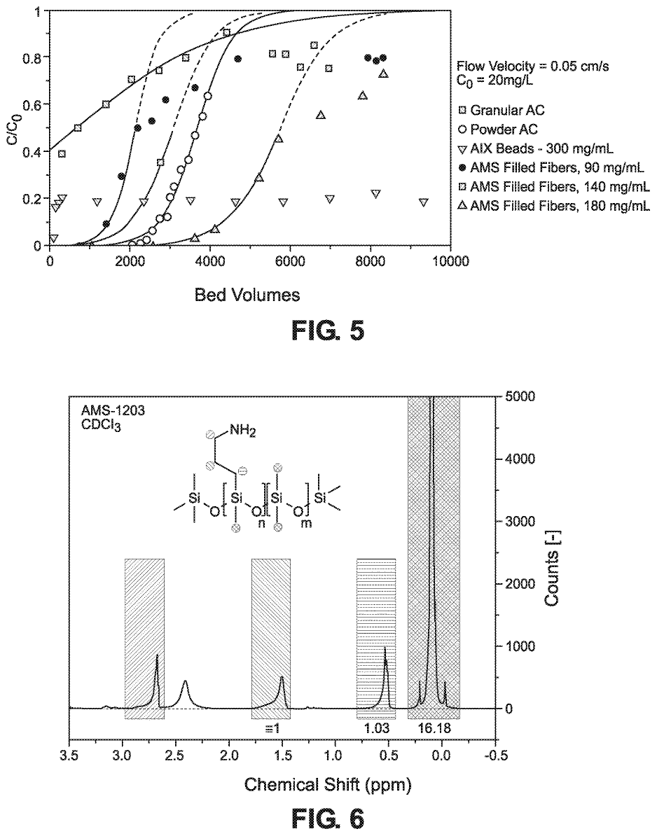

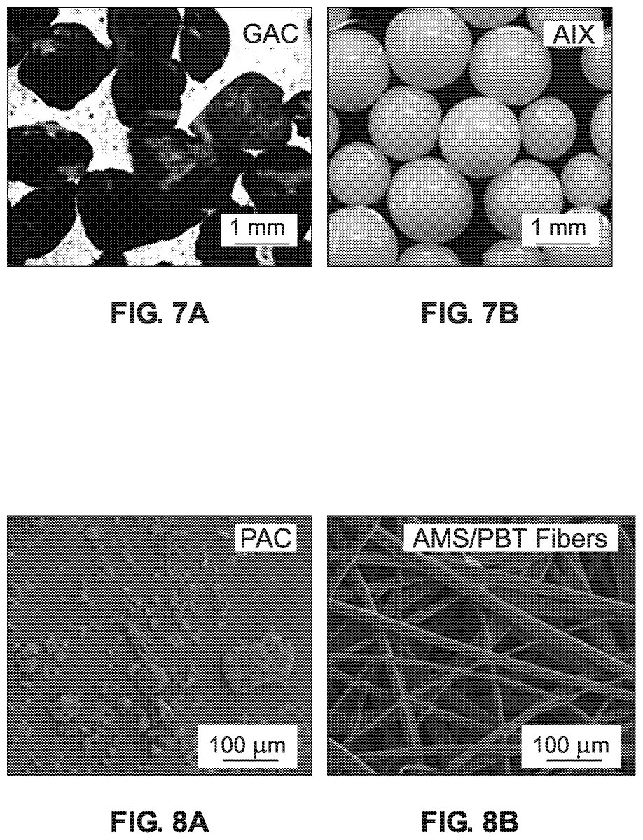

The parameters for the fits shown in FIG. 5 are summarized in Table 2 below. The fit for the granular AC excludes the first data point where the mass transfer zone may be still developing. The fits to the AMS Filled Fibers exclude the data points above C/C₀=0.5. Due to only having one data point in the breakthrough curve in the 140 mg/mL filled fiber column, the value of n was fixed at an intermediate value between the 90 mg/mL and 180 mg/mL curves and only the BV_{0.5} value was fit. The AIX breakthrough was not fit to a logistic function.

TABLE 2
Parameters for logistic equation fits of breakthrough curves

| Sample | BV_{0.5} (unitless) | n (unitless) |
|---|---|---|
| Granular AC | 680 | 0.0006 |
| Powder AC | 3700 | 0.0023 |
| AMS Filled Fibers - 90 mg/mL | 2100 | 0.0031 |
| AMS Filled Fibers - 140 mg/mL | 3100 | 0.0020* |
| AMS Filled Fibers - 180 mg/mL | 5700 | 0.0016 |

*Value of n fixed, only BV_{0.5} was fit due to only having one data point in the breakthrough

Perfluorooctanoic Acid and Polydimethylsiloxane Removal from Fibers. To extract the AMS and PFOA from the porous PBT fiber support, the sorbents were soaked in 5 mL of methanol for 24 hrs. Recovery of AMS/PFOA was determined using the mass of the porous fiber support (m_{fiber}), the mass of the dry AMS filled fibers after PFOA sorption (m_{post-sorb}), and the mass of the fibers after solvent extraction (m_{post-extract}) as shown in Equation 2 below. Average recovery was reported for 5 samples with error using a 95% confidence interval.

$$\frac{{m}_{post - extract} - {m}_{fiber}}{{m}_{post - sorb} - {m}_{fiber}} * 100 \% = AMS / PFOA Recovery \qquad ( 2 )$$

### Example 1: Comparison of AMS to Other Sorbents for PFAS Sorption

In designing a functionalization strategy for fiber PFAS sorption, a copolymer of aminopropyl-methylsiloxane and dimethylsiloxane (AMS), shown in FIG. 1A, was identified as a potentially suitable ingredient. This relatively low molecular weight polymer (number average molecular weight Mₙ=20 kg/mol) contains 2.2 mmol/g polar amine functional groups appended to a highly nonpolar backbone (44 amine groups per chain on average). Amphiphilic amine-functionalized siloxanes are used in various products such as consumer fabric softeners, epoxy and urethane modifiers, and mold release agents. AMS is a viscous liquid, which precludes its direct use as a sorbent, but enables simple loading into micron size porous fibers.

In order to qualify AMS as a PFOA sorbent the logarithmic concentration reduction of this fluorinated surfactant in water was measured versus commonly used commercial sorbents as shown in FIG. 1B. For these batch experiments, 20 mg/L of sorbent was added to a 50 mL polypropylene tube containing 1 mg/L of PFOA in deionized water. After mixing on a tube rotator for 24 hours, the aqueous supernatant was sampled to measure the remaining PFOA concentration. Two forms of activated carbon, granular (GAC) and powder (PAC), with average particle sizes of 670 and 6.4 m, respectively, were evaluated. Anion exchange beads (AIX) with an average diameter of 580 m were also tested. PAC exhibits a modestly greater sorption capacity than GAC, and both forms of activated carbon performed similarly to the AIX beads over the 24 h period. Surprisingly, a drop of the liquid AMS, wetted to the bottom of the sample tube at the same loading as the commercial sorbents (20 mg/L) matched the performance of the AIX beads. Sorption experiments using siloxanes with lower amine contents showed proportionately lower sorption capacities, which demonstrates the PFOA absorbs into the siloxane and reinforces the importance of coordinating the head group.

The sorbents tested here operate through different extraction mechanisms. Activated carbons capture contaminants onto sorption sites distributed across a high specific surface area substrate leading to large binding capacities. Ion exchange resins are beads of water swellable polymer gel functionalized with ionic chemical binding sites. Macroporous AIX beads were selected, as they exhibit efficacy in sequestering PFOA by binding the carboxylic head group with a high density of quaternary amines (3.4 mmol/g). Liquid AMS functions as a sorbent for amphiphilic PFOA through the combined action of coordination of the carboxylic head group with the amine and association of the fluorinated tail with PDMS.

### Example 2: Supporting AMS on Porous Fibers

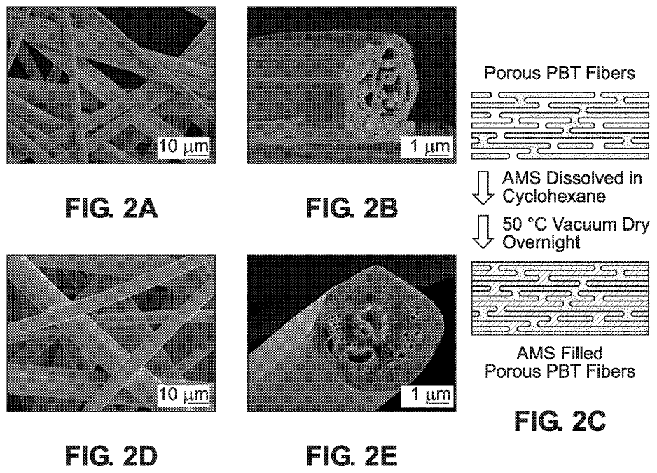

As a support, a recently demonstrated process for generating porous polybutylene terephthalate (PBT) fibers was utilized: melt blowing cocontinuous blends of PBT with polystyrene (PS) and subsequently dissolving away the PS. This scalable strategy exploits an industrialized method for producing micron- and nano-scaled fibers. In previous work it was shown that these porous supports have excellent thermal and mechanical stability. Here, fibers with an average diameter of 8.0±0.5 microns (FIG. 2A) were produced by melt blowing blends containing 35 wt % PBT, 60 wt % PS, and 5 wt % of a hydroxyl terminated PS, which resulted in a stable cocontinuous blend morphology. Extraction of the melt blown fibers with cyclohexane (CHX) removed >95% of the PS generating axially aligned and interconnected pores (FIG. 2B). Porous fiber mats were loaded with AMS by repeated evaporation of a 50 mg/mL solution in CHX resulting in about 50% by volume sorbent in the fibers (FIG. 2C). SEM images of an AMS filled fiber nonwoven mat and a fiber cross section are displayed in FIGS. 2D and 2E, showing the smooth structure of the filled surface grooves and filled internal pores. Small amounts of AMS also accumulated at fiber-fiber junction points, visible in FIG. 2D, but the vast majority of the sorbent was located within the pore structure. A detailed description of the procedures used to obtain the AMS loaded fiber mats such as those described under “Fiber Loading with Amine Functional Polydimethysiloxane” section. Batch 24 h PFOA adsorption measurements with the AMS/PBT fibers (based on 20 mg/L of sorbent) revealed a large increase in extraction efficiency over GAC, PAC, and AIX (FIG. 1i), where residual PFOA fell below the detection limit (1 μg/L) representing greater than a 1000-fold reduction in concentration. Control sorption experiments with unfunctionalized porous PBT fibers showed no significant PFOA removal, which demonstrates that the PFOA is absorbed into the AMS phase and that the porous fibers act as an inert support. This supported absorption is similar to materials termed extractant impregnated resins or a supported liquid-liquid extraction.

### Example 3: Sorption Kinetics

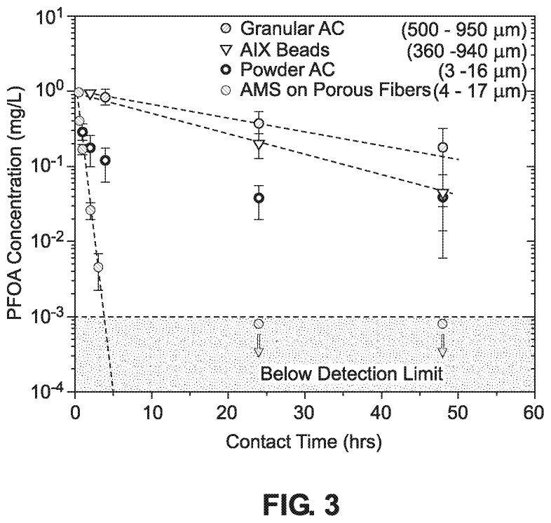

Beyond sorption capacity, faster sorption kinetics enable higher flowrates and greater throughputs in industrial systems. The sorption rate was measured by tracking the supernatant PFOA concentration over time in batch kinetic experiments (FIG. 3). The larger structure size GAC and AIX sorbents display slow linear decreases on the semi-log plot, consistent with diffusion limited sorption. This slow internal diffusion may render much of the capacity of these sorbents inaccessible in a fixed bed system, particularly at high flowrates. In contrast, the smaller PAC and AMS/PBT fibers have larger external surface areas and shorter diffusion lengths, enabling substantially faster removal of PFOA. However, whereas the PAC saturates at about 0.4 mg/L, the same loading of AMS is able to reduce the aqueous PFOA concentration below 0.001 mg/L, due to its higher sorption capacity.

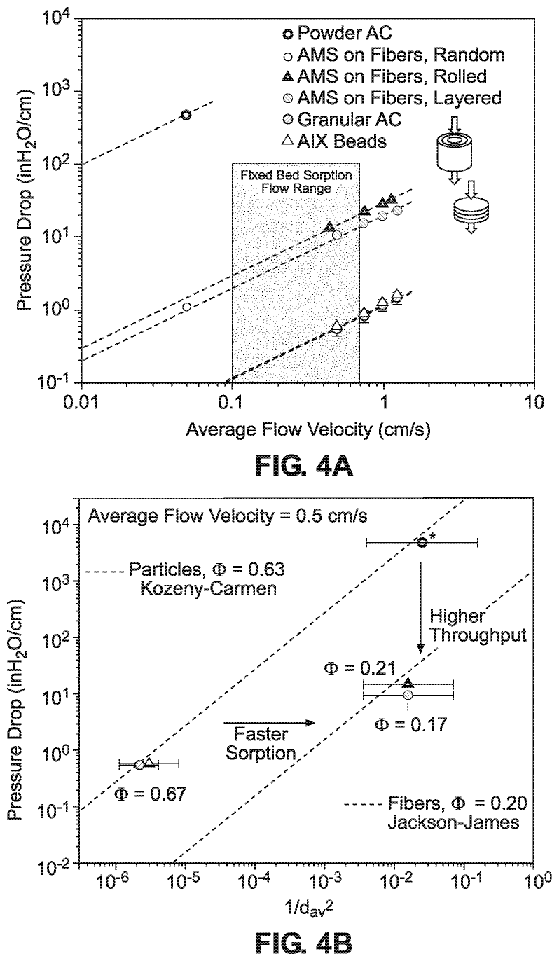

In addition to the batch sorption experiments lab scale flow experiments were conducted to quantify the sorbent flow resistance and evaluate sorption in a fixed bed geometry. Deionized water with and without PFOA was pumped through sorbent beds packed in a glass tube (9.3 mm inner diameter) at flow velocities ranging from 0.05 to 2 cm/s. Volumetric flow is a linear function of pressure drop with a zero intercept as anticipated by Darcy's law (FIG. 4A). The PAC requires more than 3.5 orders of magnitude higher pressure drop than the granular and bead sorbents, which impedes the use of powder sorbents in industrial scale bed systems. Pressure drops in packed beds scale inversely with structure size.

However, while particulate systems pack at volume fractions of φ≈0.63, fibers can be formed into mechanically stable configurations at lower volume fractions (0.1<φ<0.3). The flow resistance of the AMS/PBT fibers was characterized, prepared in rolled and layered disc forms with φ=0.21 and 0.17, respectively. Owing to the reduced φ, the fiber supported sorbents exhibit more than 2.5 orders of magnitude lower flow resistance than the PAC, despite having a similar structure size, and conform with empirical predictions for bed pressure drops with no fitting parameters (FIG. 4B).

Small scale breakthrough experiments were conducted by pumping 20 mg/L PFOA solution (C₀) through the particulate and fiber sorbent beds and tracked the normalized outlet concentration (C/C₀) over time. Plotting C/C₀ against the eluted volume leads to breakthrough curves, which provide an additional measure of sorption kinetics. Breakthrough curves for beds of GAC, PAC, AIX, and AMS/PBT fibers with lengths between 3.5 and 6 mm are shown in FIG. 5. With the high feed concentration and short bed lengths, the granular AC and AIX beads showed immediate breakthrough. The powder AC instead resisted breakthrough and showed a sharp breakthrough curve indicative of rapid sorption due to the small structure size. However, as discussed previously the PAC requires orders of magnitude higher head pressures to operate. Lastly, the AMS/PBT fibers matched and outperformed the powder AC with a fraction of the flow resistance. The breakthrough curves in FIG. 5 show data from three beds which supported 90, 140, and 180 mg/mL of AMS and were packed at φ of 28%, 24%, and 36%, respectively. As expected, higher loadings of AMS shift the breakthrough curve consistent with an increase in the bed capacity. The data are well-described by a two-parameter logistic function as shown in FIG. 5 particularly at C/C₀ values below 0.5. The deviation from the fits above C/C₀=0.5 has also been observed in breakthrough curves of extractant impregnated resins and in the adsorption of large solute species. In both cases, initial sorption is rapid and slows once binding sites reach a threshold saturation. In the AMS loaded fibers, this suggests that diffusion of PFOA through the AMS may limit access to sites at the core of the fibers or that a sharp change in the sorption equilibrium occurs at concentrations higher than ~10 mg/L. Smaller diameter fibers and lower PFOA concentrations may alleviate this effect. Nonetheless, the agreement with the fit at lower C/C₀ demonstrates the high density of accessible absorption sites in AMS afforded by the micron size fiber structure. Samples from the column effluent analyzed by NMR showed no detectable siloxanes above the baseline levels in blank samples (<0.5 mg/L), demonstrating the AMS is retained by the fiber support.

### Example 4: Recoverability of Support and Containment of PFOA

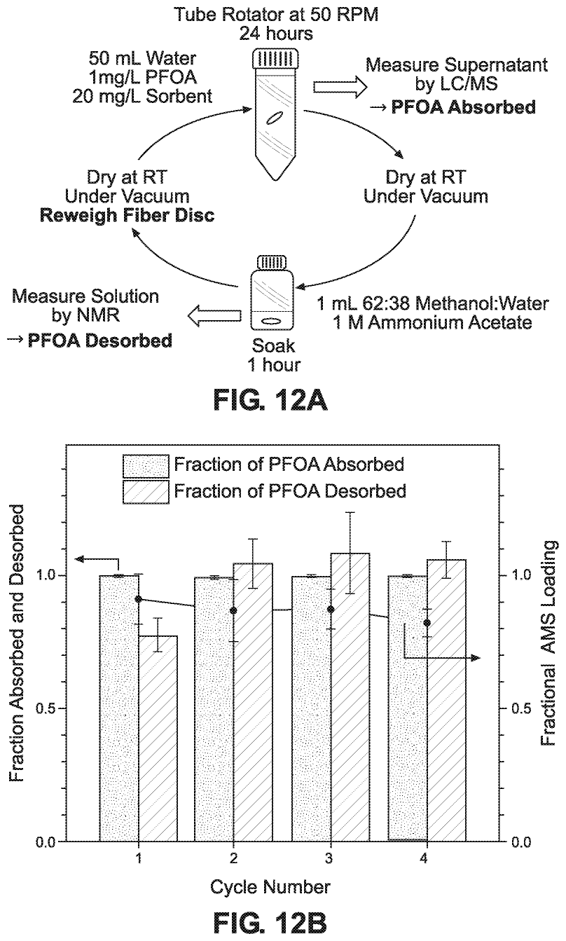

The recoverability of sorbed PFOA and the regeneration efficiency of the AMS loaded PBT were evaluated using the scheme outlined in FIG. 12A. The AMS/PBT fibers were soaked in 50 mL of a 1 mg/L PFOA solution for 24 hrs before sampling the supernatant to determine the PFOA fractional removal. The fiber discs were then removed, dried, and soaked in a 1 M ammonium acetate solution in 62:38 volume ratio mixture of methanol and water for 1 hr. The PFOA concentration in this solution (~50 mg/L) was then measured to determine the fractional desorption. Fibers were then dried and reweighed to evaluate the loading stability before being added to a fresh 1 mg/L PFOA solution to measure sorption for the next cycle.

Fractional removal is shown in FIG. 12B with the AMS/PBT fibers removing >99% of the PFOA after every cycle. On desorption, the first cycle showed incomplete recovery at 77±6%. Similar desorption experiments with longer soaking times also showed low recoveries on the first cycle, suggesting some sorbed PFOA may remain at equilibrium with the regeneration solution or that some fraction of the sorption sites are not recoverable. Nonetheless, all the subsequent desorption cycles showed recoveries within error of 100%. Attempts to simply regenerate the AMS/PBT fibers with pure methanol led to near complete removal of the AMS (97±%). While complete removal would likely be useful for a full replacement of the AMS, here its is show the use of an ammonium acetate in the methanol/water solution, as this is able to selectively extract the PFOA. FIG. 12B shows a slight, but statistically significant decrease in the AMS loading with repeated sorption cycles, however it is theorized that through optimizing the regeneration solution composition, the loaded AMS could be further stabilized. Moreover, it is anticipated that lightly crosslinking the AMS on the fibers will improve the loading stability, however this would make full removal of the AMS more challenging or infeasible.

This work reports on the remarkable PFOA sorption affinity of amine functional silicone oils, a commercially available component in commodity fabric softeners. This work demonstrates the utility of fiber-based sorbents for the removal of trace water contaminants. The functionalized porous melt blown fibers show rapid sorption kinetics and low resistance to fluid flow relative to particle-based materials. Additionally, the remarkable PFOA sorption affinity of amine functional silicone oils, a commercially available component in commodity fabric softeners, is demonstrated. The AMS chemistry further generalizes the range of materials which can be used to remove PFAS while enabling simple loading onto support structures like porous fibers. The fiber supported amine siloxanes produced here show rapid sorption kinetics and low resistance to fluid flow relative to particle-based sorbents. This regenerative technology should be readily scalable for implementation in municipal water treatment facilities. Together, the new absorbent chemistry and its implementation on porous fiber supports, offer an attractive approach to achieving economically viable remediation of harmful PFAS contaminants. This regenerative technology utilizes industrially accessible processing methods and materials, offering a promising approach to achieve economically viable remediation of harmful PFAS contaminants from highly contaminated sources like industrial effluents. Further study of these siloxane absorbents should be conducted to assess their applicability to environmental remediation.

1. A method of removing a contaminant from a liquid, the method comprising:
exposing a liquid that may comprise a contaminant to a sorbent, the sorbent comprising an amine functionalized siloxane, and the sorbent forming a sorbent/contaminant complex with any contaminant of the liquid;
followed by a step of separating the liquid from the sorbent;
wherein the sorbent absorbs or adsorbs a contaminant; and
wherein separation of the sorbent/contaminant compound complex from the liquid removes the contaminant from the liquid.

2. The method of claim 1, wherein the sorbent is formed from a copolymer of a compound comprising an amine group and a functionalized siloxane has a structure of 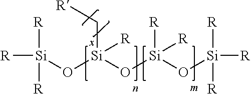
each R is independently a hydrogen, an alky or aryl group consisting of 1 to 10 carbons,
R′ is an amine or salt thereof comprising —NH₂, —NHR, —NR₂, —NH—(CH₂)_{y}—NH₂, or —NR₃⁺, wherein y is 1 to 12,
n is 0 to 10000,
m is 0 to 10000, and
x is 1 to 10.

3. The method of claim 1, wherein the sorbent comprises a copolymer of an amine group and a functionalized siloxane comprises an amine group that is an aminopropyl-siloxane, an aminoethyl-siloxane, an aminobutyl-siloxane, an aminopentyl-siloxane, an aminohexyl-siloxane, or an aminopropyl-methylsiloxane; and the functionalized siloxane is a methyl siloxane.

4. The method of claim 1, wherein the sorbent is a copolymer of aminopropyl-methylsiloxane and dimethylsiloxane.

5. The method of claim 3, wherein the sorbent copolymer comprises 1.0 mmol/g to about 10 mmol/g amine functional groups in the copolymer.

6. The method of claim 1, wherein the sorbent is a liquid or slurry.

7. The method of claim 5, wherein the sorbent/contaminant complex is separated from the liquid by centrifugation.

8. The method of claim 1, wherein the sorbent is a liquid loaded onto a solid media or the sorbent is crosslinked or is covalently linked to a solid media.

9. The method of claim 8, wherein the solid media is a melt-blown porous fiber or electrospun porous fiber.

10. The method of claim 8, wherein the solid media comprises a porous fiber that is formed from a polystyrene, a polyester, a polyether, a polyamide, a vinyl polymer, a polyolefin, a nylon, a polybutylene terephthalate polymer, a nylon, or any combination thereof.

11. The method of claim 1, wherein the sorbent comprises an amine functionalized siloxane sorbent and a second sorbent that is an activated charcoal, an anion exchange resin, or a cationic exchange resin.

12. The method of claim 1, further comprising a step of collecting and processing the sorbent/contaminant complex to recover the sorbent for a second use and containment of the contaminant.

13. The method of claim 1, wherein the contaminant is a perfluoroalkyl compound.

14. A media for absorbing a contaminant from a liquid comprising an absorbent loaded onto a solid substrate or a sorbent is crosslinked or is covalently linked to a solid substrate,
wherein the sorbent is formed from a copolymer of a compound comprising an amine group and a functionalized siloxane has a structure of: 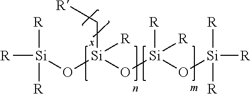
each R is independently a hydrogen, an alky or aryl group consisting of 1 to 10 carbons,
R′ is an amine or salt thereof comprising —NH₂, —NHR, —NR₂, —NH—(CH₂)_{y}—NH₂, or —NR₃⁺ wherein y is 1 to 12,
n is 0 to 10000
m is 0 to 10000
x is 1 to 10.

15. The media of claim 14, wherein the contaminant is a perfluoroalkyl compound.

16. The media of claim 14, wherein the sorbent is formed from a copolymer of a compound comprising an amine group and a functionalized siloxane,
wherein the compound comprising an amine group is an aminopropyl-siloxane, an aminoethyl-siloxane, an aminobutyl-siloxane, an aminopentyl-siloxane, an aminohexyl-siloxane, or an aminopropyl-methylsiloxane; and
the functionalized siloxane is a methyl siloxane.

17. The media of claim 14, wherein the sorbent copolymer comprises 1.0 mmol/g to about 10 mmol/g amine functional groups in the polymer.

18. The media of claim 14, wherein the solid substrate comprises a fiber or porous fiber that is formed from a polystyrene, a polyester, a polyether, a polyamide, a vinyl polymer, a polyolefin, a nylon, a polybutylene terephthalate polymer, a nylon, or any combination thereof or,
wherein the media is a porous media, or wherein the solid substrate is a melt-blown porous fiber or electrospun porous fiber.

19. A method of making a media for absorbing a perfluoroalkyl compound contaminant from a liquid, the method comprising:
providing a blend polymers, the blend comprising a polystyrene, a polyester, a polyether, a polyamide, a vinyl polymer, a polyolefin, a nylon, a polybutylene terephthalate polymer, a nylon, or any combination thereof,
creating a fiber from the blend of polymer,
treating the fiber to form a porous fiber;
adding to the porous fiber with an amine functionalized siloxane.

20. The method of claim 21, wherein the fiber comprises a polystyrene polymer and a polybutylene terephthalate polymer and treatment of the fiber to form a porous fiber comprises extraction with a cyclohexane, or
wherein saturating the porous fiber with an amine functionalized siloxane comprises combining repeated cycles of application to the porous fiber with a solution of the amine functionalized siloxane and cyclohexane and evaporation.
